(19) United States
(12) Patent Application Publication
(10) Pub. No.: US 2004/0170108 A1
(43) Pub. Date: Sep. 2, 2004

(54) Optical pickup apparatus

(75) Inventors: Byung-Ryul Ryoo, Suwon-si (KR); Dong-Ryeol Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/687,764

(22) Filed: Oct. 20, 2003

(30) Foreign Application Priority Data
Dec. 10, 2002 (JP) 2002-78164

(51) Int. Cl. G11B 7/135

(52) U.S. Cl. 369/112.08

(57) ABSTRACT

An optical pickup apparatus in which an arrangement and adjustment of optical elements is easy. The optical pickup apparatus includes a light source to emit laser light; a beam splitter to change the travel path of incident light; an objective lens to condense light passed through the beam splitter to form a light spot on an optical recording medium; and a photodetector to receive light reflected from the optical recording medium and then passed through the beam splitter to detect an information signal and an error signal. The optical pickup apparatus further includes a grating for diffraction-transmitting incident light; a wavelength plate to change polarization characteristic of incident light; and an optical output compensating lens to compensate output of light incident from the light source. The grating, the wavelength plate, and the optical output compensating lens are disposed on an optical path between the light source and the beam splitter. At least two of the grating, the wavelength plate, and the optical output compensating lens are formed in one body.

### CROSS-REFERENCE TO RELATED APPLICATIONS

This application claims the priority of Korean Patent Application No. 2002-78164, filed on Dec. 10, 2002, in the Korean Intellectual Property Office, the disclosure of which is incorporated herein in its entirety by reference.

### BACKGROUND OF THE INVENTION

1. Field of the Invention

The present invention relates to an optical pickup apparatus to record and reproduce information on and from a high-speed and high-density recording medium, and more particularly, to an optical pickup apparatus of which optical elements are formed in one body so that the optical elements can be disposed and adjusted easily.

2. Description of the Related Art

Generally, optical pickup apparatuses record information on an optical recording medium or reproduce recorded information therefrom using light emitted from a light source in a non-contact manner. Together with the development of optical recording media such as CDs and DVDs, the optical pickup apparatuses have multifunctions in order to be used for both CDs and DVDs. Further, as high-speed and high-density recording media are developed, the structures of multifunctional optical pickup apparatuses become very complicated.

Referring to FIG. 1, a conventional optical pickup apparatus suitable for a high-speed and high-density recording medium includes a light source 11 to emit light, a beam splitter 19 to change the travel path of incident light, an objective lens 25, a collimating lens 21, and a photodetector 29. The objective lens 25 is disposed on an optical path between the beam splitter 19 and an optical recording medium D to condense incident light on the optical recording medium D. The collimating lens 21 is disposed on an optical path between the beam splitter 19 and the objective lens 25 and converges divergent light to make the divergent light into parallel light. The photodetector 29 receives light reflected from the optical recording medium D and then passed through the beam splitter 19 to detect an information signal and an error signal.

The photodetector 29 includes a plurality of partition plates which receive light independently and photoelectric-transform the light. The photodetector 29 detects an information signal, a track error signal, and a focus error signal recorded on the optical recording medium D by selectively differential-amplifying and adding signals in each of the partition plates.

Here, a reflecting member 23 is provided on an optical path between the collimating lens 21 and the objective lens 25 and reflects incident light to change the travel path of the incident light in consideration of the optical arrangement of the optical pickup apparatus.

Further, the optical pickup apparatus includes a grating 13, a wavelength plate 15, and a condensing lens 17 which are disposed on an optical path between the light source 11 and the beam splitter 19. The condensing lens 17 first condenses divergent light emitted from the light source 11.

A diffraction pattern 13a is formed on one surface of the grating 13 so that incident light is diffraction-transmitted into 0 order, +1 order, ±2 order, . . . etc. The diffraction-transmitted light is used to detect the track error signal by a three-beam method using the photodetector 29. The wavelength plate 15 changes a polarization of incident light in order for circular polarized light to be incident on the optical recording medium D. The condensing lens 17 condenses divergent light so that defocus of a light spot focused on the optical recording medium D is adjusted and the cross-sectional diameter of the divergent light is reduced, thereby increasing an effective quantity of light.

Further, a sensor lens 27 is provided between the beam splitter 19 and the photodetector 29 and changes a focal length and a cross-sectional size of light proceeding to the photodetector 29.

Since the conventional optical pickup apparatus configured as described above includes the plurality of optical elements in order to correspond to the high-speed and high-density recording medium, the arrangement and assembly of the optical elements are complicated. Particularly, since the grating 13, the wavelength plate 15, and the condensing lens 17 are disposed within a narrow space between the light source 11 and the beam splitter 19, the arrangements of the grating 13, the wavelength plate 15, and the condensing lens 17 are complicated and the assembly thereof is very tight. As such, thermal reliability of the optical pickup apparatus may be reduced due to an increase in the number of optical elements included in the optical pickup apparatus. In addition, manufacturing cost of the optical pickup apparatus is increased due to the individual manufacturing cost of the optical elements.

### SUMMARY OF THE INVENTION

The present invention includes an optical pickup apparatus of which at least two optical elements are formed in one body in order to overcome a structural drawback, to improve the assembly performance, and reduce manufacturing cost.

According to an aspect of the present invention, there is provided an optical pickup apparatus comprising a light source which emits laser light; a beam splitter which changes the travel path of incident light; an objective lens which condenses light passed through the beam splitter to form a light spot on an optical recording medium; and a photodetector which receives light reflected from the optical recording medium and then passed through the beam splitter to detect an information signal and an error signal. The optical pickup apparatus further comprises a grating, a wavelength plate, and an optical output compensating lens which are disposed on an optical path between the light source and the beam splitter. The grating diffraction-transmits incident light, the wavelength plate changes a polarization characteristic of incident light, and the optical output compensating lens compensates output of light incident from the light source. At least two of the grating, the wavelength plate, and the optical output compensating lens are formed in one body.

The optical pickup apparatus further comprises a holder in which the light source is fixed and disposed; and a cylinder, in which at least two of the grating, the wavelength plate, and the optical output compensating lens are fixed and disposed and which can move in an optical axis direction with respect to the holder and can be installed rotatably. A position of the cylinder can be adjusted in the optical axis direction and a rotation direction with respect to the holder.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 schematically shows an optical arrangement of a conventional optical pickup apparatus;

FIGS. 2 and 3 schematically show an optical arrangement of an optical pickup apparatus according to a first embodiment of the present invention;

FIG. 4 is an exploded perspective view showing a mechanical arrangement of a main part of the optical pickup apparatus shown in FIG. 2;

FIGS. 5 and 6 schematically show an optical arrangement of a portion of an optical pickup apparatus according to a second embodiment of the present invention; and

FIGS. 7 and 8 schematically show an optical arrangement of a portion of an optical pickup apparatus according to a third embodiment of the present invention.

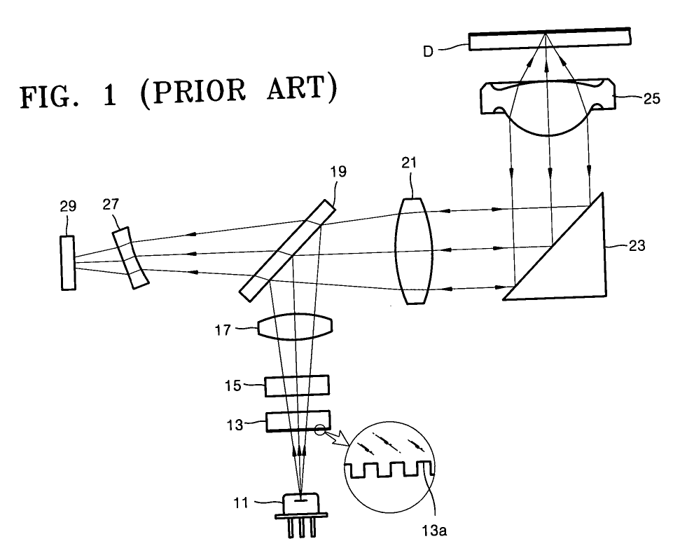

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

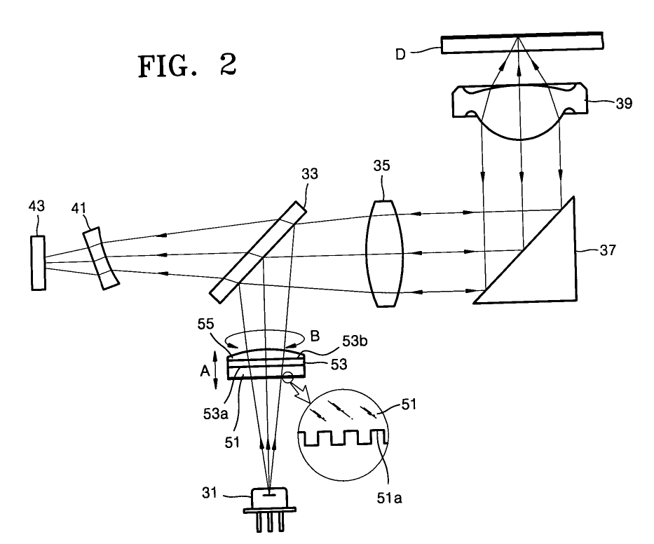

Referring to FIG. 2, an optical pickup apparatus according to a first embodiment of the present invention includes a light source 31 to emit laser light, a beam splitter 33 to change the travel path of incident light, an objective lens 39 to condense incident light to form a light spot on an optical recording medium D, and a photodetector 43 to receive light reflected from the optical recording medium D and then passed through the objective lens 39 and the beam splitter 33.

According to an aspect of the invention, a collimating lens 35 is further included on an optical path between the beam splitter 33 and the objective lens 39, to condense divergent light and make the divergent light into parallel light in order for parallel light to be incident on the objective lens 39.

Further, in another aspect, a reflecting member 37 is provided on an optical path between the collimating lens 35 and the objective lens 39, to reflect incident light to change the travel path of the incident light in consideration of the optical arrangement of the optical pickup apparatus.

The beam splitter 33 may be a beam splitter which transmits and reflects incident light by dividing the incident light into a predetermined ratio of quantity of light, or a polarized beam splitter which transmits and reflects incident light according to a polarization characteristic. Further, although the plate beam splitter 33 is shown in FIG. 2, a cubic beam splitter may be used.

Further, a hologram element may be used as the beam splitter 33. A hologram pattern is formed on one surface of the hologram element so that light incident on one surface, on which the hologram pattern is formed, is transmitted straight and light incident on the other surface is diffraction-transmitted, thereby changing the travel path of light. Since the hologram element is well known, its description will be omitted.

The photodetector 43 includes a plurality of partition plates which receive light independently and photoelectric-transform the light. The photodetector 43 detects an information signal, a track error signal, and a focus error signal recorded on the optical recording medium D by selectively differential-amplifying and adding signals in each of the partition plates. Here, in an embodiment of the invention, a three-beam method is used as a method to detect the track error signal using the photodetector 43.

A sensor lens 41 is disposed on an optical path between the beam splitter 33 and the photodetector 43. The sensor lens 41 is inclined opposite to a direction in which the beam splitter 33 is inclined to compensate for coma aberration and adjust a focal length and a size of incident light.

The reflecting member 37 is provided on an optical path between the collimating lens 35 and the objective lens 39 and reflects incident light to change the travel path of the incident light in consideration of the optical arrangement of the optical pickup apparatus.

The optical pickup apparatus according to the first embodiment of the present invention includes a grating 51, a wavelength plate 53, and an optical output compensating lens 55, which are disposed on an optical path between the light source 31 and the beam splitter 33, in order to record and reproduce information on and from a high-speed and high-density recording medium.

A diffraction pattern 51a is formed on one surface of the grating 51 so that incident light is diffraction-transmitted into 0 order, +1 order, ±2 order, . . . etc. The diffraction-transmitted light is used to detect the track error signal by a three-beam method using the photodetector 43.

The wavelength plate 53 changes a polarization of incident light so circular polarized light is incident on the optical recording medium D.

The optical output compensating lens 55 adjusts defocus of a light spot focused on the optical recording medium D and reduces a cross-sectional diameter of divergent light by condensing the divergent light, so that an effective quantity of light is increased and the output of light incident from the light source 31 is compensated.

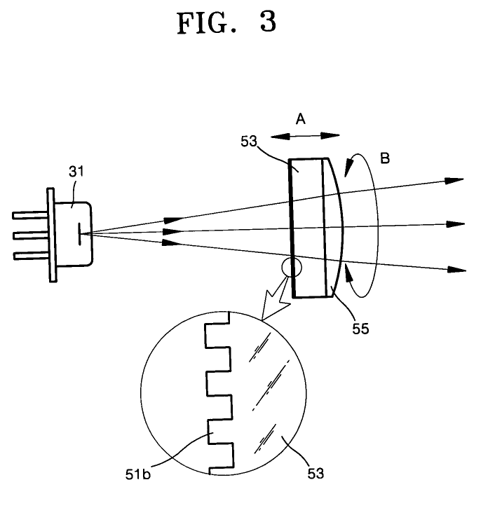

The optical output compensating lens 55 may be configured using a convex lens as shown in FIGS. 2 and 3. In addition, the optical output compensating lens 55 may be configured using a plate lens to condense incident light by forming a predetermined diffraction pattern as in a Fresnel lens. Since, the structure of the optical output compensating lens 55 is well known, its description will omitted.

The optical pickup apparatus according to the first embodiment of the present invention includes at least two of the grating 51, the wavelength plate 53, and the optical output compensating lens 55 formed in one body.

Referring to FIG. 2, all of the grating 51, the wavelength plate 53, and the optical output compensating lens 55 are formed in one body.

That is, the grating 51 is coupled and formed on an optical incident surface 53a of the wavelength plate 53, and the optical output compensating lens 55 is coupled and formed on an optical emitting surface 53a of the wavelength plate 53.

Here, the grating 51 and the wavelength plate 53 are manufactured individually, and then are bonded using an adhesive.

Another method, as shown in FIG. 3, a grating pattern 51b is directly formed on one surface of the wavelength plate 53 using a predetermined semiconductor process, so that the grating 51 and the wavelength plate 53 are formed in one body.

Meanwhile, the grating 51, the wavelength plate 53, and the optical output compensating lens 55, which are formed in one body, are installed to be adjustable with respect to the light source 31.

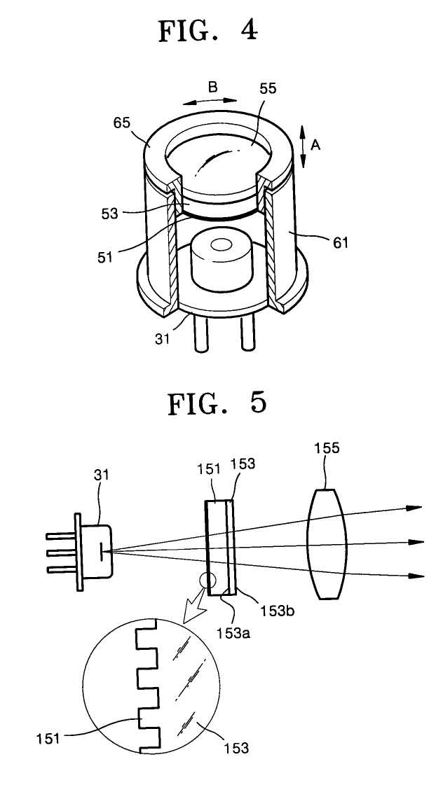

Referring to FIG. 4, the light source 31 and the one-body optical elements are disposed on the same optical path through a holder 61, in which the light source 31 is fixed, and a cylinder 65, in which the one-body optical elements are included. At least two selected from the grating 51, the wavelength plate 53, and the optical output compensating lens 55 are included within the cylinder 65. In FIG. 4, all of the grating 51, the wavelength plate 53, and the optical output compensating lens 55 are installed within the cylinder 65.

The cylinder 65 can move in an optical axis direction with respect to the holder 61, that is, a direction indicated by an arrow A, and also can be installed rotatably as indicated by an arrow B.

Thus, optical positions of the grating 51, the wavelength plate 53, and the optical output compensating lens 55 can be adjusted with respect to the light source 31 by adjusting a position of the cylinder 65 in the optical axis direction and a rotation direction with respect to the holder 61.

That is, the degree of the defocus of the light spot focused on the optical recording medium D and a distance between light beams diffracted through the grating 51 can be adjusted due to the adjustment of the cylinder 65 in the optical axis direction. Further, a phase of the wavelength plate 53 can be adjusted by changing an installation angle of the wavelength plate 53 due to the adjustment of the cylinder 65 in the rotation direction.

Further, optical positions of the light source 31, the grating 51, the wavelength plate 53, and the optical output compensating lens 55 can be adjusted with respect to other optical elements of the optical pickup apparatus by adjusting the entire holder 61 and the entire cylinder 65 in the optical axis direction and the rotation direction.

An optical pickup apparatus according to a second embodiment of the present invention includes substantially the same optical elements and has the same optical arrangement as the optical pickup apparatus according to the first embodiment of the present invention described with reference to FIG. 2. Only, in the second embodiment of the present invention, an optical element installed in front of the light source 31 is modified.

Referring to FIG. 5, a grating 151, a wavelength plate 153, and an optical output compensating lens 155 are disposed in front of the light source 31, and the grating 151 and the wavelength plate 153 are formed in one body. That is, the grating 151 is coupled and formed on an optical incident surface 153a of the wavelength plate 153. Further, the grating 151 may be coupled and formed on an optical emitting surface 153b of the wavelength plate 153.

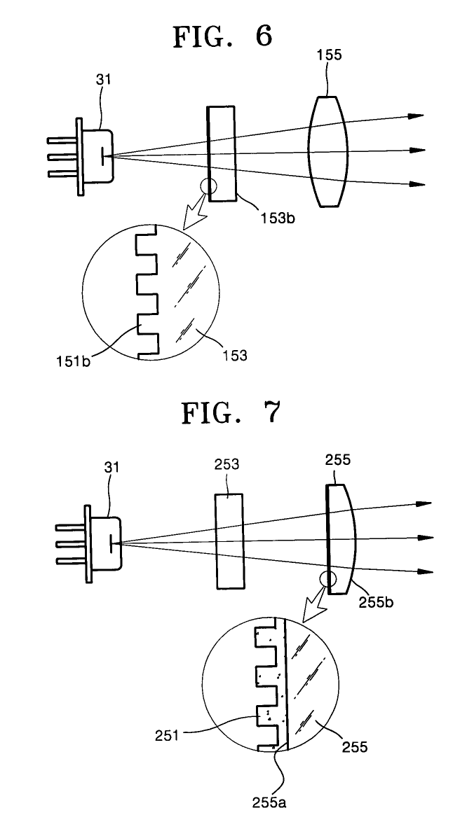

As another method, as shown in FIG. 6, a grating pattern 151b is directly formed on one surface of the wavelength plate 153 using a predetermined semiconductor process, so that the grating 151 and the wavelength plate 153 are formed in one body.

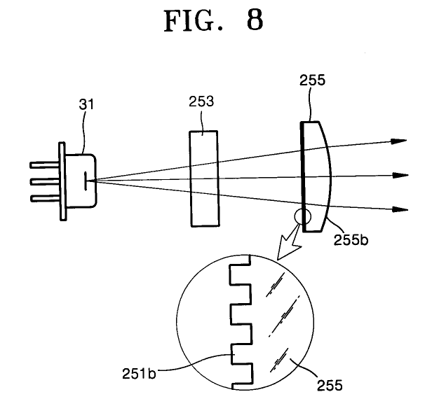

In an optical pickup apparatus according to a third embodiment of the present invention, as shown in FIG. 7, a grating 251, a wavelength plate 253, and an optical output compensating lens 255 are disposed in front of a light source 31, and the grating 251 and the optical output compensating lens 255 are formed in one body. That is, the grating 251 is coupled on an optical incident surface 255a of the optical output compensating lens 255, and then the grating 251 and the optical output compensating lens 255 are formed in one body. Here, the grating 251 may be coupled and formed on an optical emitting surface 255b of the optical output compensating lens 255. Further, as shown in FIG. 8, a grating pattern 251b may be directly formed on one surface of the optical output compensating lens 255 using a predetermined semiconductor process, and then the grating 251 and the optical output compensating lens 255 may be formed in one body.

Further, although it is not shown in the present invention, the grating 51 (refer to FIG. 2) is disposed separately and the wavelength plate 53 and the optical output compensating lens 55 may be formed in one body.

As described above, since at least two of optical elements disposed between a light source and a beam splitter are formed in one body, a structural drawback of an optical pickup apparatus can be overcome, the assembly performance of the optical pickup apparatus can be improved, and manufacturing cost can be reduced. Further, since optical positions of the one-body optical elements can be easily adjusted with respect to the light source, the performance of the optical pickup apparatus can be improved.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup apparatus comprising:
a light source which emits laser light;
a beam splitter which changes the travel path of incident light;
an objective lens which condenses light passed through the beam splitter to form a light spot on an optical recording medium; and
a photodetector which receives light reflected from the optical recording medium and then passed through the beam splitter to detect an information signal and an error signal,
wherein the optical pickup apparatus further comprises a grating which diffraction-transmits incident light, a wavelength plate which changes polarization characteristic of incident light, and an optical output compensating lens which compensates output of light incident from the light source, all of which being disposed on an optical path between the light source and the beam splitter,
wherein at least two of the grating, the wavelength plate, and the optical output compensating lens are formed in one body.

2. The optical pickup apparatus of claim 1, wherein the grating is formed on an optical incident surface and/or an optical emitting surface of the wavelength plate, so that the grating and the wavelength plate are formed in one body.

3. The optical pickup apparatus of claim 2, wherein the wavelength plate, which is formed in one body with the grating, is bonded to the optical output compensating lens.

4. The optical pickup apparatus of claim 1, wherein the grating is formed on an optical incident surface and/or an optical emitting surface of the optical output compensating lens, so that the grating and the optical output compensating lens are formed in one body.

5. The optical pickup apparatus of claim 1, wherein the wavelength plate and the optical output compensating lens are bonded to each other.

6. The optical pickup apparatus of claim 1, further comprising:
a holder in which the light source is fixed; and
a cylinder, in which at least two of the grating, the wavelength plate, and the optical output compensating lens are fixed and which is movable in an optical axis direction with respect to the holder and is installed rotatably,
wherein a position of the cylinder is adjustable in the optical axis direction and a rotation direction with respect to the holder.

7. The optical pickup apparatus of claim 1, wherein the grating is formed on an optical incident surface of the wavelength plate, so that the grating and the wavelength plate are formed in one body.

8. The optical pickup apparatus of claim 7, wherein the wavelength plate, which is formed in one body with the grating, is bonded to the optical output compensating lens.

9. The optical pickup apparatus of claim 1, wherein the grating is formed on an an optical emitting surface of the wavelength plate, so that the grating and the wavelength plate are formed in one body.

10. The optical pickup apparatus of claim 9, wherein the wavelength plate, which is formed in one body with the grating, is bonded to the optical output compensating lens.

11. The optical pickup apparatus of claim 1, wherein the grating is formed on an optical incident surface of the optical output compensating lens, so that the grating and the optical output compensating lens are formed in one body.

12. The optical pickup apparatus of claim 1, wherein the grating is formed on an optical emitting surface of the optical output compensating lens, so that the grating and the optical output compensating lens are formed in one body.

13. The optical pickup apparatus of claim 2, further comprising:
a holder in which the light source is fixed; and
a cylinder, in which at least two of the grating, the wavelength plate, and the optical output compensating lens are fixed and which is movable in an optical axis direction with respect to the holder and can be installed rotatably,
wherein a position of the cylinder is adjustable in the optical axis direction and a rotation direction with respect to the holder.

14. The optical pickup apparatus of claim 3, further comprising:
a holder in which the light source is fixed; and
a cylinder, in which at least two of the grating, the wavelength plate, and the optical output compensating lens are fixed and which is movable in an optical axis direction with respect to the holder and can be installed rotatably,
wherein a position of the cylinder is adjustable in the optical axis direction and a rotation direction with respect to the holder.

15. The optical pickup apparatus of claim 4, further comprising:
a holder in which the light source is fixed; and
a cylinder, in which at least two of the grating, the wavelength plate, and the optical output compensating lens are fixed and which is movable in an optical axis direction with respect to the holder and can be installed rotatably,
wherein a position of the cylinder is adjustable in the optical axis direction and a rotation direction with respect to the holder.

16. The optical pickup apparatus of claim 5, further comprising:
a holder in which the light source is fixed; and
a cylinder, in which at least two of the grating, the wavelength plate, and the optical output compensating lens are fixed and which is movable in an optical axis direction with respect to the holder and can be installed rotatably,
wherein a position of the cylinder is adjustable in the optical axis direction and a rotation direction with respect to the holder.
